(19) United States
(12) Patent Application Publication
(10) Pub. No.: US 2006/0013682 A1
(43) Pub. Date: Jan. 19, 2006

(54) Turbocharger with compressor stage flow conditioner

(76) Inventors: Steven P. Martin, Walnut, CA (US); Scott G. Aguilar, La Cresenta, CA (US); Glenn F. Thompson, Palos Verdes Estates, CA (US); John M. Wilson, Redondo Beach, CA (US); Steve Coleman, Cypress, CA (US)

Correspondence Address: HONEYWELL TURBO TECHNOLOGIES, 23326 HAWTHORNE BOULEVARD, SUITE #200, TORRANCE, CA, 90505, US

(21) Appl. No.: 11/230,692

(22) Filed: Sep. 20, 2005

Related U.S. Application Data
(63) Continuation of application No. 10/414,337, filed on Apr. 15, 2003.

(51) Int. Cl. F03B 11/08

(52) U.S. Cl. 415/121.2

(57) ABSTRACT

Turbochargers comprise a compressor housing having an air inlet passage for receiving inlet airflow, an air outlet passage for passing pressurized air to an engine combustion system, and a compressor impeller rotatably disposed within the housing for receiving air from the air inlet passage, pressurizing the inlet air, and passing the pressurized air to the air outlet passage. An air flow conditioner is placed into air flow communication with the compressor housing air inlet passage, and can be disposed within an air inlet section of the compressor itself, or can be placed within a vehicle air ducting positioned upstream from the turbocharger. The air flow conditioner comprises a body that is specially designed having a plurality of air passages disposed therethrough to cause a desired flow conditioning effect on air passing through it and to the compressor to offset the onset of compressor surge during engine operation, thereby shifting the compressor operating efficiency curve to the left to broaden the operating efficiency window for the turbocharger compressor.

This application is a continuation of a copending U.S. patent application bearing Ser. No. 10/414,337 filed on Apr. 15, 2003.

### FIELD OF THE INVENTION

This invention relates to turbochargers as used with gasoline and diesel-powered internal combustion engines and, more particularly, to turbochargers comprising an air flow conditioner in air flow communication with a turbocharger compressor inlet air flow path for conditioning compressor inlet air to help offset compressor surge.

### BACKGROUND

Turbochargers for gasoline and diesel-powered internal combustion engines are devices known in the art that are used for pressurizing or boosting the intake air stream, routed to a combustion chamber of the engine, by using the heat and volumetric flow of exhaust gas exiting the engine. Specifically, the exhaust gas exiting the engine is routed into a turbine housing of the turbocharger in a manner that causes an exhaust gas-driven turbine wheel to spin within the housing.

The exhaust gas-driven turbine is mounted onto one end of a shaft that is common to a radial air compressor impeller mounted onto an opposite end of the shaft and rotatably disposed within a compressor housing. Thus, rotary action of the turbine wheel also causes the compressor impeller to spin within the compressor housing. The spinning action of the compressor impeller causes intake air to enter the compressor housing and be pressurized or boosted a desired amount before it is mixed with fuel and combusted within the engine combustion chamber.

Conventional fixed geometry turbochargers are designed to provide desired improvements in engine performance during a defined range or window of engine operating conditions.

Within such defined range of engine operating conditions, the turbocharger compressor operates to provide a desired level of both boosted airflow and air pressure. Conventional fixed geometry turbochargers are unable to provide desired engine performance improvements during all engine operating conditions.

The typical operating range of a conventional turbocharger compressor stage is insufficient to provide a proper match of the compressor to the entire range of possible engine operating conditions. For example, a compressor that is designed to match maximum engine air flow requirements may not have a sufficient operating margin to provide matched engine air flow at engine low air flow operating conditions (i.e., near a surge limit of the compressor), and a compressor that is designed to provide matched air flow to the engine at engine low air flow operating conditions may not be able to provide the necessary high air flow to the engine at engine high flow operating conditions.

Thus, the task of designing a turbocharger represents an inherent compromise of being able to provide some non-optimal degree of performance increase, within a targeted engine operating window, without significantly detrimentally impacting engine performance outside of the targeted engine operating window. The turbocharger designer oftentimes works to provide a turbocharger capable of providing a desired level of improved engine performance over an engine operating range thought to be most important for a particular engine/vehicle application. Such conventional turbochargers are oftentimes designed to provide the desired engine performance improvements at mid to high-load engine operating conditions, i.e., operating conditions where engine performance characteristics of increased torque and/or horsepower are desired.

Additionally, it is desired that the turbocharger be capable of providing such desired engine performance improvements while having a desired service life and without itself being damaged. The phenomena of “compressor surge” is one that is known to occur at turbocharger/engine operating conditions where the engine intake air flow demand is reduced or fixed during turbocharger operating conditions, and where the compressor outlet air boost pressure is maintained or increased, respectively. This can happen, for example, under engine operating conditions such as when the engine is lugged down at full load conditions, or during shifting when the throttle is lifted.

During compressor surge a sort of flow slow down or reversal occurs within the compressor housing, where the compressor impeller spins faster than the air being moved by it in the compressor housing. This unmatching or decoupling of air flow to the compressor impeller within the compressor housing is known to slow down and impose unwanted stress onto the compressor impeller, which can adversely impact engine performance and reduce the service life of the turbocharger.

It is, therefore, desired that a turbocharger be constructed in a manner that operates to offset compressor surge. It is desired that turbochargers of this invention be constructed in a manner that also does not significantly impact turbocharger operation, increase noise and/or reduce the service life during nonsurge engine operating conditions.

### SUMMARY OF THE INVENTION

Turbochargers constructed in accordance with the principles of this invention generally comprise a compressor housing that includes an air inlet passage for receiving inlet airflow, and an air outlet passage for passing pressurized air to an engine combustion system. A compressor impeller is rotatably disposed within the housing for receiving air from the air inlet passage, pressurizing the inlet air, and passing the pressurized air to the air outlet passage.

An air flow conditioner is placed into air flow communication with the compressor housing air inlet passage. The air flow conditioner can be disposed within an air inlet section of the compressor itself, or can be placed within a vehicle air ducting positioned upstream from the turbocharger. The air flow conditioner comprises a body that is specially designed having a plurality of air passages disposed therethrough to cause a desired flow conditioning effect on air passing through it and to the compressor.

The air flow conditioner functions to offset the onset of compressor surge during engine operation, thereby shifting the compressor operating efficiency curve to the left to broaden the operating efficiency window for the turbocharger compressor. Broadening of the compressor efficiency curve is desired for the purpose of increasing the effective operating range of the turbocharger with the engine, reducing the possibility of increased noise and/or surge-related turbocharger damage, effectively increasing turbocharger service life.

### BRIEF DESCRIPTION OF THE DRAWINGS

Details and features of the present invention will become more clearly understood with respect to the detailed description and drawings in which:

FIGS. 1A and 1B are a respective cross-sectional side elevational drawing and a front elevational drawing of an example air flow conditioner of this invention;

FIGS. 2A and 2B are a respective cross-sectional side elevational drawing and a front elevational drawing of another example air flow conditioner of this invention

FIGS. 3 to 9 are cross-sectional side elevational drawings and front elevational drawings illustrating a number of different attachment techniques for attaching an air flow conditioner of this invention into an air inlet section of a compressor housing; and

FIG. 10 is a compressor map that graphically illustrates a turbocharger compressor performance curve or map with and without the air flow conditioner of this invention.

### DETAILED DESCRIPTION

Turbochargers constructed in accordance with this invention comprise an air flow conditioner positioned in air flow communication with a compressor housing air inlet that is designed to condition the air passing through it for the purpose of offsetting unwanted compressor surge and, thereby broadening the effective operating range or window of the turbocharger.

Turbochargers constructed in accordance with this invention comprise the typical elements of turbochargers used with gasoline and diesel-powered internal combustion, such as: a center housing containing a common shaft and shaft journal assembly; a turbine housing having a radially disposed exhaust inlet, and axially disposed exhaust outlet, and a turbine wheel rotatably disposed therein and attached to an end of the common shaft; and a compressor housing having an axially disposed air inlet, a radially disposed pressurized air outlet, and a compressor impeller rotatably disposed therein and attached to an opposite end of the common shaft.

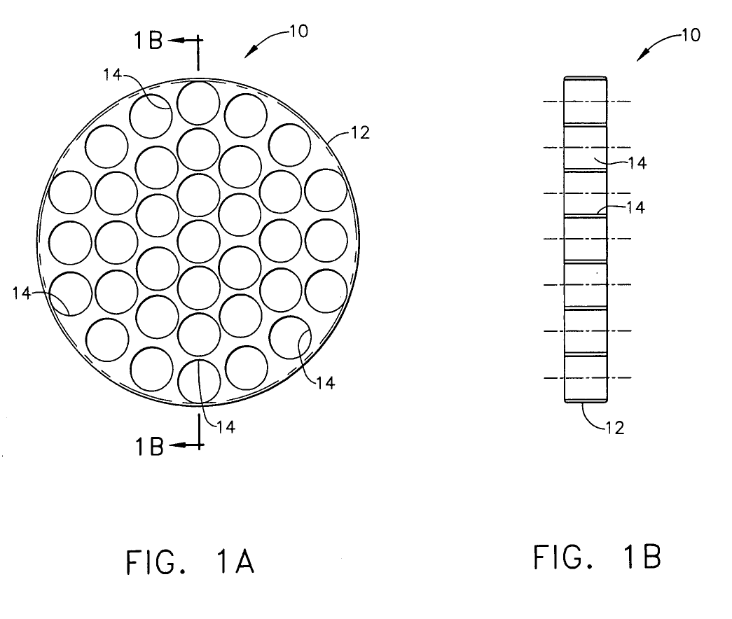

FIGS. 1A and 1B illustrate an example embodiment of an air flow conditioner 10, constructed in accordance with the principles of this invention. The air flow conditioner 10 comprises a body 12 having a plurality of air flow passages or openings 14 disposed axially therethrough. The openings 14 can be of any geometric shape, and the body is ideally shaped having an outside edge surface configured to fit within an inlet air flow passage in communication with the compressor housing air inlet.

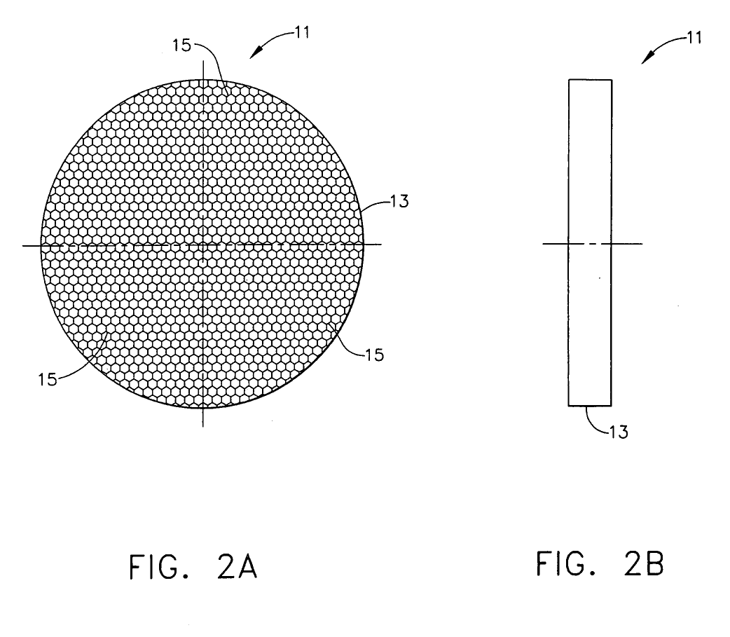

Air flow conditioners 10 of this invention can be constructed for placement within an air inlet ducting of a vehicle, that is in air-flow communication with the turbocharger compressor housing air inlet, or can be constructed for placement within the air inlet section of the compressor housing itself. In an example embodiment, illustrated in FIGS. 1 and 2, the air flow conditioner 10 is configured having a disk-shaped body 12 with a plurality of circular air flow passages 14 disposed therethrough, and having a diameter sized to accommodate placement within an inlet section of a compressor housing. Alternatively, the air flow conditioner can be configured having a honeycomb-type body (as illustrated in FIGS. 2A and 2B) with air flow passages of various cell geometries and dimensions.

The air flow conditioner 10 can be formed from any type of suitable structural material suitable for placement within the respective air flow passage. For applications where the air flow conditioner is placed within a vehicle intake air ducting, the air flow conditioner can be formed from plastic or other suitable nonmetallic structural material because it is not necessarily subjected to the extreme operating temperatures of the turbocharger. For applications where the air flow conditioner is placed within the compressor housing air inlet section, the air flow conditioner is preferably formed from a metallic structural material that is capable of withstanding the extreme operating temperatures of the turbocharger. The air flow conditioner 10 can be formed by conventional methods such as by machining or molding.

The number and size of air flow passages 14 through the air flow conditioner body 12 will depend on the size, application of the turbocharger, and desired performance characteristics of the turbocharger and turbocharged engine. Functionally, the size and number of air flow passages will be that needed to provide a desired compressor surge offset, i.e., shifting the compressor performance map to the left of its normal operating curve, thereby increasing the lower end of the effective operating range for the turbocharger, without adversely impacting the flow rate of air into the compressor housing during operating conditions of maximum air flow engine demand. The air flow conditioner body has an axial thickness calculated to both provide a desired amount of rigidity to the structure itself in view of the air flow passages, and to have a proper passage length-to-diameter (l/d) ratio necessary to provide the required amount of flow conditioning without producing excessive restriction to the air flow, causing a pressure drop and decreasing maximum flow.

Generally speaking, to achieve the desired air flow conditioning results, it is desired that the air inlet passages 14 comprise in the range of from between 55 to 95 percent of the total air flow conditioner surface area and, more preferably in the range of from about 80 to 90 percent of the total surface area. Ultimately, this ratio would depend on the size and configuration of the particular flow conditioner. For example, the ratio of air inlet passage surface area to total flow conditioner surface area can be different for a flow conditioner as illustrated in FIGS. 1A and 1B from one having a honeycomb structure (illustrated in FIGS. 2A and 2B). An air flow conditioner having total surface area of air flow passages below about 55 may not be desired because too little air inlet surface area would result in excessive blockage leading to pressure drop and loss of maximum air flow. An air flow conditioner having a surface area ratio greater than 95 percent may not be desired because it would not operate to effectively broaden the turbocharger compressor map, thereby not sufficiently offsetting the onset of compressor surge. The desired surface area range provided above represents that amount needed to provide a desired amount of flow conditioning, broadening of the turbocharger compressor map to offset the onset of surge, while also providing a minimum amount of pressure drop therethrough.

Additionally, it is generally desired that the air inlet openings be sufficiently sized to as to perform the function of flow conditioning without introducing an unwanted pressure drop. It is desired that the air inlet openings not be so small that they be prone to fouling or plugging from airborne debris in the turbocharger air flow, thereby producing an unwanted pressure drop and reduced maximum air flow. Additionally, if the air inlet passage walls are too thin they could be prone to mechanical damage during handling or turbocharger operation. Openings that are too large may reduce the effectiveness of the flow conditioner to broaden the compressor map.

In an example embodiment, as illustrated in FIGS. 1A and 1B, an air flow conditioner sized to fit within the air inlet section of a GTA45 turbocharger, manufactured by Garrett Engine Boosting Systems, has a circular body diameter of approximately 120 mm, and has approximately 35 circular air passages disposed therethrough that are each approximately 15 mm in diameter. The air flow conditioner has a thickness of approximately 15 mm, and is machined from aluminum. If desired, the air flow conditioner could be molded, and/or could be formed from an alternate material such as an engineered plastic.

FIGS. 2A and 2B illustrate another example embodiment of an air flow conditioner 10, constructed in accordance with the principles of this invention, that in many respects is similar to that discussed above and illustrated in FIGS. 1A and 1B, except that the air flow conditioner body 13 comprises a plurality of honeycomb-shaped, i.e., hexagonal, air flow passages or openings 15 disposed axially therethrough.

As noted above, the exact number and size of air flow passages 15 through the air flow conditioner body 13 will depend on the size, application of the turbocharger, and desired performance characteristics of the turbocharger and turbocharged engine. Functionally, the size and number of air flow passages will be that needed to provide a desired compressor surge offset, i.e., shifting the compressor performance map to the left of its normal operating curve, thereby increasing the lower end of the effective operating range for the turbocharger, without adversely impacting the flow rate of air into the compressor housing during operating conditions of maximum air flow engine demand.

As also noted above, to achieve the desired air flow conditioning results, it is desired that the air inlet passages 15 comprise in the range of from between 55 to 95 percent of the total air flow conditioner surface area and, more preferably in the range of from about 80 to 90 percent of the total surface area.

In an example embodiment, as illustrated in FIGS. 2A and 2B, an air flow conditioner 11 sized to fit within the air inlet section of a designated turbocharger has a circular body diameter of approximately 116 mm, and can have in the range of from 300 to 1300 hexagonally-shaped air passages disposed therethrough that are each in the range of from about 3 to 6 mm in diameter (as measured between diametrically-opposed flat sections). The air flow conditioner 11 has a thickness of approximately 13 mm, and is machined from aluminum. If desired, the air flow conditioner could be molded, and/or could be formed from an alternate material such as an engineered plastic.

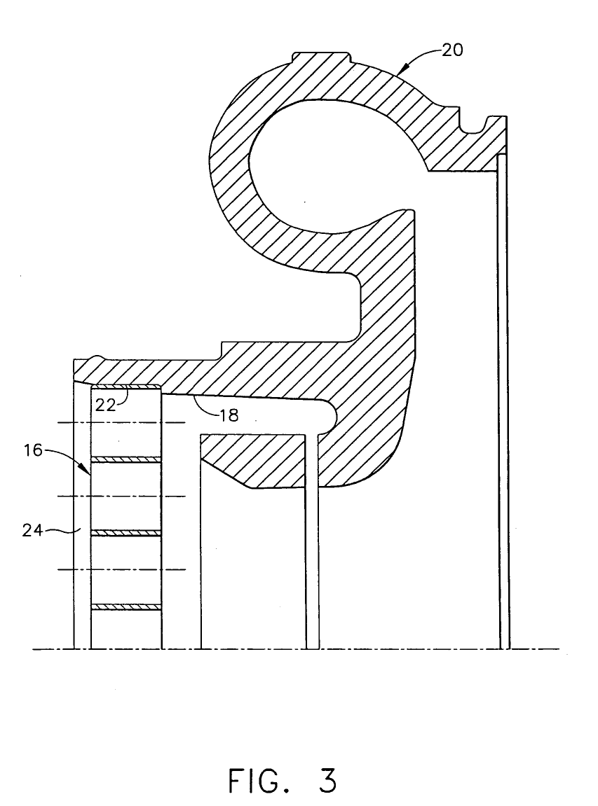

FIGS. 3 to 9 illustrate different techniques of connecting air flow conditioners of this invention within an air inlet section of a compressor housing. FIG. 3 illustrates an embodiment of the air flow conditioner 16 that is disposed within an air inlet section 18 of a compressor housing 20. Specifically, the air flow conditioner 16 is positioned within a shoulder 22 configured along an inside circumference of air inlet section adjacent an air inlet lip 24.

The shoulder 22 is sized having an inside diameter that provides an interference fit with the outside diameter of the air flow conditioner body to retain the air flow conditioner within the compressor housing. If desired, a suitable adhesive, welding agent and/or sealant can be interposed between the air flow conditioner and the shoulder to adhesively join or seal the adjacent surfaces.

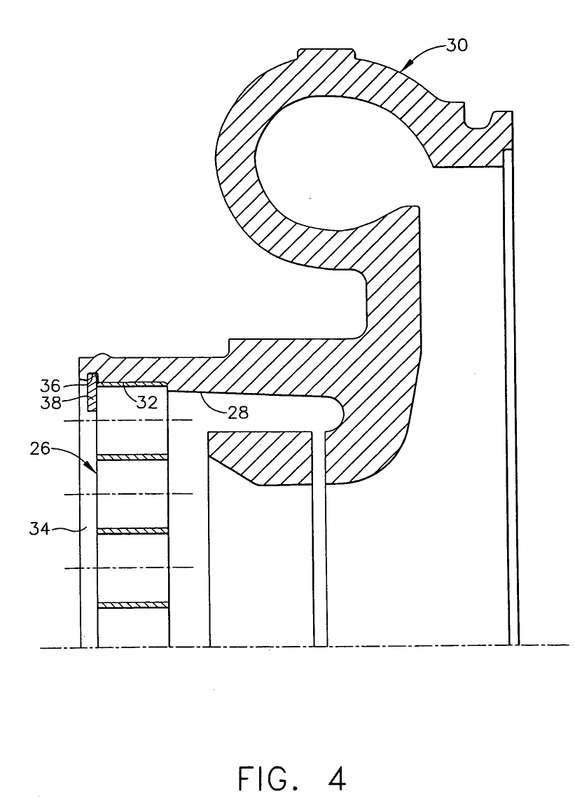

FIG. 4 illustrates an embodiment of the air flow conditioner 26 that is disposed within an air inlet section 28 of a compressor housing 30. Specifically, the air flow conditioner 26 is positioned within a shoulder 32 configured along an inside circumference of air inlet section adjacent an air inlet lip 34. The shoulder 32 is sized to accommodate placement of the outside diameter of the air flow conditioner body therein.

The shoulder 32 includes a groove 36 disposed therein adjacent the lip 34 that is sized to accommodate placement of a retaining ring 38 therein. The groove is positioned next to an axial edge of the air flow conditioner such that placement of the ring 38 within the groove operates to lock the air conditioner ring into the shoulder 32 to prevent outward axial movement of the air flow conditioner therefrom.

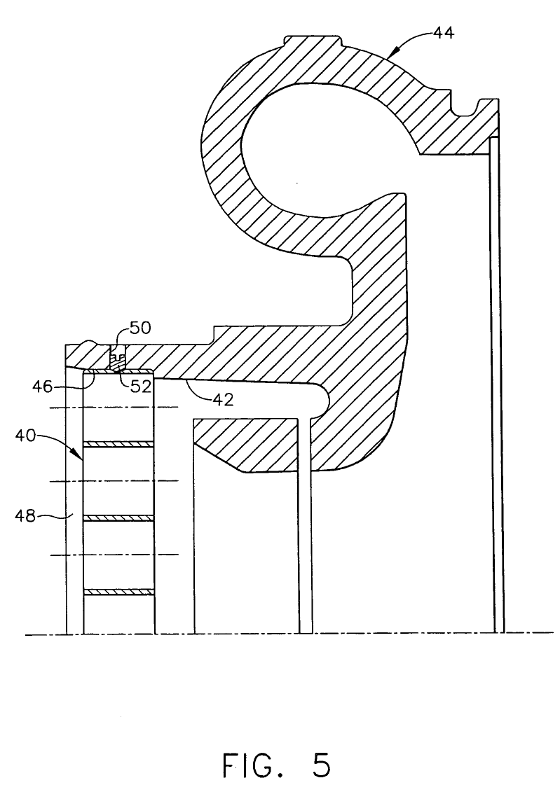

FIG. 5 illustrates an embodiment of the air flow conditioner 40 that is disposed within an air inlet section 42 of a compressor housing 44. Specifically, the air flow conditioner 40 is positioned within a shoulder 46 configured along an inside circumference of air inlet section adjacent an air inlet lip 48. The shoulder 46 is sized to accommodate placement of the outside diameter of the air flow conditioner body therein.

The shoulder 46 includes one or more radially directed openings 50 disposed therethrough that are sized to accommodate placement of a pin or screw 52 therein. The air flow conditioner can have an outside diameter edge that is configured to accept placement of the pin or screw thereagainst. Placement of the pin or screw within opening and against the air flow diameter edge operates to retain the air conditioner ring into the shoulder 46 and prevent outward axial movement of the air flow conditioner therefrom.

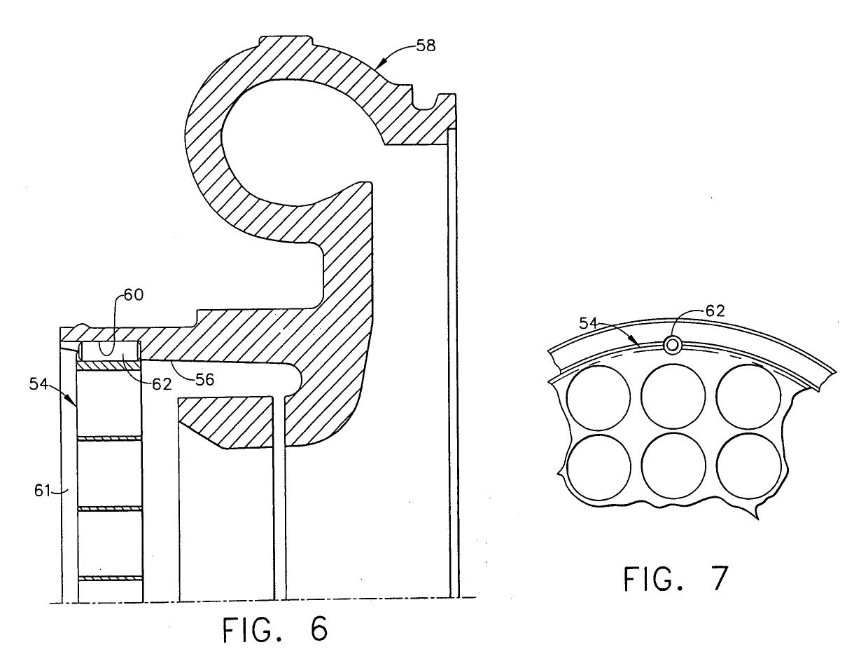

FIGS. 6 and 7 illustrate an embodiment of the air flow conditioner 54 that is disposed within an air inlet section 56 of a compressor housing 58. Specifically, the air flow conditioner 54 is positioned within a shoulder 60 configured along an inside circumference of air inlet section adjacent an air inlet lip 61. The shoulder 60 is sized to accommodate placement of the outside diameter of the air flow conditioner body therein.

The shoulder 60 includes one or more axially directed grooves disposed therealong that are sized to accommodate placement of a pin or screw 62 therein. The air flow conditioner can have an outside diameter edge that is configured to accept placement of the pin or screw thereagainst. Placement of the pin or screw axially within the groove and against the air flow diameter edge operates to retain the air flow conditioner within the shoulder 60 and prevent outward axial movement of the air flow conditioner therefrom.

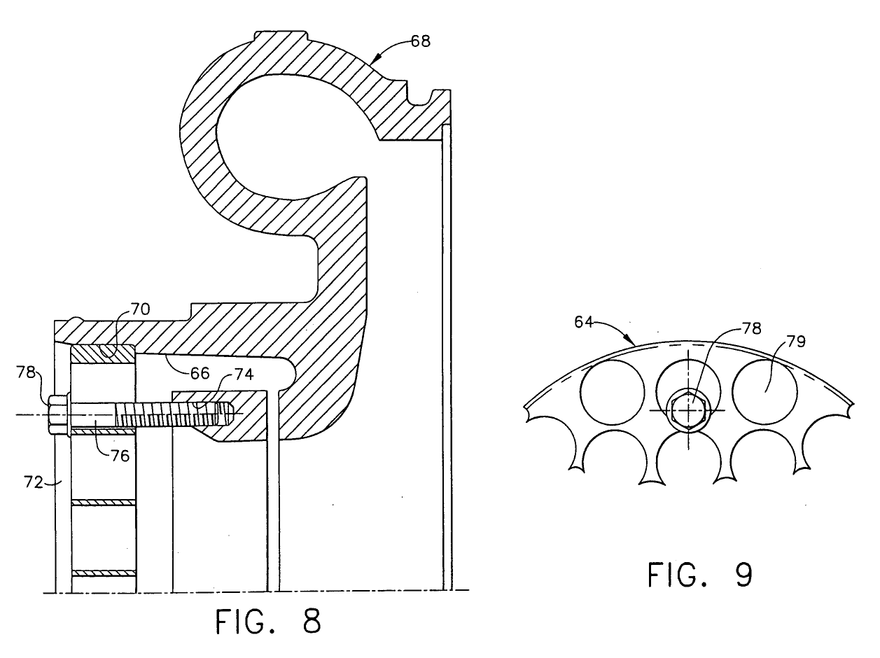

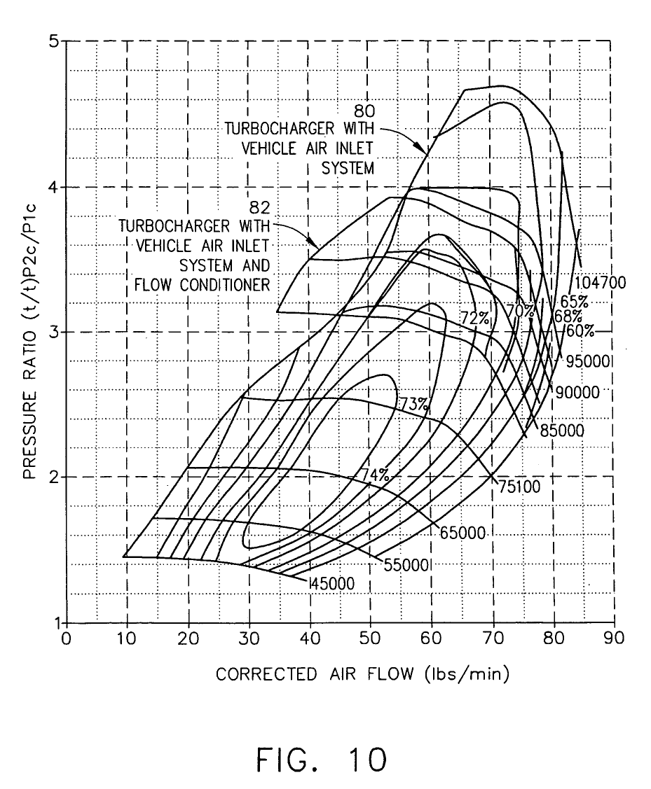

FIGS. 8 and 9 illustrate an embodiment of the air flow conditioner 64 that is disposed within an air inlet section 66 of a compressor housing 68. Specifically, the air flow conditioner 64 is positioned within a shoulder 70 configured along an inside circumference of air inlet section adjacent an air inlet lip 72. The shoulder 70 is sized to accommodate placement of the outside diameter of the air flow conditioner body therein.

The compressor housing is configured having an axially directed threaded opening 74 disposed therein for accommodating threaded placement of an attachment screw 76 therein. The attachment screw 76 is sized to engage the threads of the opening 74 and retain placement of the air flow conditioner within the compressor housing by placement of its screw head 78 against an outwardly facing axial air flow conditioner surface.

In an example embodiment, the attachment screw 76 and threaded opening 74 are configured to permit passage of the screw through one of the air flow conditioner air flow passages 79, and placement of a portion of the screw head 78 against an edge of the same air flow passage. Configured in this manner, tightening of the attachment screw axially within the opening moves the screw head against the air flow conditioner surface, operating to secure the air flow conditioner into the shoulder 70 and prevent outward axial movement of the air flow conditioner therefrom.

These are but a few examples of how air flow conditioners of this invention can be attached or connected within an air inlet section of a compressor housing. It is to be understood that other techniques and attachment mechanisms, and variations of the above-described techniques and attachment mechanisms, can be used to facilitate the attachment of flow conditioners in compressor housings and are intended to be within the scope of this invention. Additionally, similar types of attachment techniques can be used for alternative placement of the air flow conditioner within the air inlet ducting of a vehicle.

A key feature of air flow conditioners of this invention is the ability to treat or condition the flow of inlet air as it is passed through the conditioner and into the compressor housing in a manner that offsets compressor surge. Air flow conditioners of this invention do this without adversely impacting the ability of air to flow through the conditioner at maximum engine inlet air flow operating conditions. Thus, air flow conditioners of this invention function to increase or broaden the effective operating range or window for the turbocharger. Additionally, offsetting the onset of compressor surge operates to reduce compressor induced noise and/or reduce potential surge-related damage caused to the compressor impeller, thereby functioning also to increase the effective turbocharger service life.

FIG. 10 illustrates a compressor map for an example turbocharger. The map plots the compressor rpm curves and efficiency curves or envelopes as a function of air flow v. pressure ratio. A first efficiency envelope 80 represents the compressor operating window for a turbocharger that does not include an air flow conditioner of this invention. Compressor surge for this example turbocharger compressor occurs in the region of the graph to the left of the envelope line. For example, for a representative rpm range of from 85,000 to 95,000, compressor surge for this non-flow conditioner equipped turbocharger occurs at air flow rates starting below 40 lbs/min (at the low rpm end) and moving up to about 57 lbs/min (at the high rpm end). At a pressure ratio of approximately 3.2, the maximum choke flow is approximately 83 lb/min, the minimum surge flow is 47 lb/min, and the compressor map width is approximately 36 lb/min.

A second efficiency envelope 82 represents a compressor operating window for the same turbocharger that is equipped with the air flow conditioner of this invention. As graphically illustrated, use of the air flow conditioner operates to shift the compressor curve to the left of curve 80 (within the same rpm region of from about 85,000 to 95,000) without significantly impacting the right side of the curve, thereby operating to broaden the effective engine operating window using this particular turbocharger. For this flow conditioner equipped turbocharger, the compressor surge occurs at air flow rates starting below 35 lbs/min (at the low rpm end) and moving up to about 55 lbs/min (at the high rpm end). At a pressure ratio of approximately 3.2, the maximum choke flow is approximately 81 lb/min (a minor reduction of about 2.4%), the minimum surge flow is 36 lb/min (a shift of about 23.4%), and the compressor map width is approximately 45 lb/min (a broadening of about 25%).

Having now described the invention in detail, those skilled in the art will recognize modifications and substitutions to the specific embodiments disclosed herein. Such modifications are within the scope and intent of the present invention. Additionally, air flow conditioners of this invention can be used in conjunction with devices other than turbochargers as disclosed above and illustrated. For example, air flow conditioners of this invention can be used with other types of air pressurizing devices such as compressors and superchargers. In such alternative applications, air flow conditioners can be placed either within an air inlet portion of the device or within air ducting that is in air-flow communication with the device to condition the air in a manner providing the above-noted benefits to the air pressurizing device.

What is claimed is:

1. A turbocharger comprising:
a compressor housing including an air inlet passage for receiving inlet airflow, an air outlet passage for passing pressurized air to an engine combustion system, and a compressor impeller rotatably disposed within the housing for receiving air from the air inlet passage, pressurizing the inlet air, and passing the pressurized air to the air outlet passage; and
an air flow conditioner placed in air flow communication with the compressor housing air inlet passage, the air flow conditioner comprising a body having a plurality of air passages disposed therethrough.

2. The turbocharger as recited in claim 1 wherein the air flow conditioner has a disk-shaped body and is disposed within the air inlet passage of the compressor housing.

3. The turbocharger as recited in claim 2 wherein the air flow conditioner air passages are circular in configuration.

4. The turbocharger as recited in claim 2 wherein the air flow conditional air passages are hexagonal in configuration

5. The turbocharger as recited in claim 2 wherein the air flow conditioner air passages comprise in the range of from between 55 to 95 percent of the total air flow conditioner surface area.

6. The turbocharger as recited in claim 2 wherein the air flow conditioner air passages comprise in the range of from between 80 to 90 percent of the total air flow conditioner surface area.

7. The turbocharger as recited in claim 2 further comprising means for retaining the air flow conditioner in the compressor housing.

8. A turbocharger comprising:
a compressor housing including an air inlet passage for receiving inlet airflow, an air outlet passage for passing pressurized air to an engine combustion system, and a compressor impeller rotatably disposed within the housing for receiving air from the air inlet passage, pressurizing the inlet air, and passing the pressurized air to the air outlet passage;
an air flow conditioner disposed within the compressor housing air inlet passage, the air flow conditioner comprising a disk-shaped body having a plurality of air passages disposed therethrough; and
means for retaining the air flow conditioner within the compressor housing.

9. The turbocharger as recited in claim 8 wherein the air flow conditioner air passages comprise in the range of from between 55 to 95 percent of the total air flow conditioner surface area.

10. The turbocharger as recited in claim 8 wherein the air flow conditioner air passages comprise in the range of from between 80 to 90 percent of the total air flow conditioner surface area.

11. A turbocharger comprising:
a compressor housing including an air inlet passage for receiving inlet airflow, an air outlet passage for passing pressurized air to an engine combustion system, and a compressor impeller rotatably disposed within the housing for receiving air from the air inlet passage, pressurizing the inlet air, and passing the pressurized air to the air outlet passage;
an air flow conditioner disposed within the compressor housing air inlet passage, the air flow conditioner comprising a disk-shaped body positioned diametrically across the air inlet passage, the body having a plurality of air passages disposed therethrough to condition inlet airflow upstream of the compressor impeller; and
means for retaining the air flow conditioner within the compressor housing.

12. The turbocharger as recited in claim 11 wherein the air flow conditioner air passages comprise in the range of from between 55 to 95 percent of the total air flow conditioner surface area.

13. The turbocharger as recited in claim 11 wherein the air flow conditioner air inlet passages comprise in the range of from between 80 to 90 percent of the total air flow conditioner surface area.

14. An air pressurizing device comprising:
a housing including an air inlet passage for receiving inlet airflow, an air outlet passage for passing pressurized air from the housing, and an air pressurizing member disposed within the housing for receiving air from the air inlet passage, pressurizing the inlet air, and passing the pressurized air to the air outlet passage; and
an air flow conditioner placed in air flow communication with the housing air inlet passage, the air flow conditioner comprising a body having a plurality of air passages disposed therethrough.
